(19) United States
(12) Patent Application Publication
(10) Pub. No.: US 2013/0021438 A1
(43) Pub. Date: Jan. 24, 2013

(54) 3D VIDEO PROCESSING UNIT

(71) Applicant: Lawrence J. Tucker, Whitmore Lake, MI (US)

(72) Inventor: Lawrence J. Tucker, Whitmore Lake, MI (US)

(73) Assignee: DESIGN & TEST TECHNOLOGY, INC., Ann Arbor, MI (US)

(21) Appl. No.: 13/637,822

(22) PCT Filed: Mar. 30, 2011
(86) PCT No.: PCT/US11/30471

§ 371 Date: Sep. 27, 2012

Related U.S. Application Data
(60) Provisional application No. 61/319,485, filed on Mar. 31, 2010.

(51) Int. Cl. H04N 13/00

(52) U.S. Cl. 348/43; 348/E13.003

(57) ABSTRACT

The 3D video processing unit combines video feeds from two unsynchronized video sources, such as left and right video cameras, in real-time, to generate a 3D image for display on a video monitor. The processing unit can also optionally receive video data from a third video source and use that data to generate a background image visible on all or a selected portion or portions of the video monitor. An alpha data generator inspects the video data held within respective buffer circuits associated with the left and right channels and generates an alpha data value for each pixel. These alpha data values are used within an alpha blending mixer to control whether a pixel is displayed or suppressed. Synchronization of the unsynchronized video sources occurs within the processing unit after alpha data values have been generated for each left and right channels.

### CROSS-REFERENCE TO RELATED APPLICATIONS

This application claims the benefit of U.S. Provisional Application No. 61/319,485, filed on Mar. 31, 2010. The entire disclosure of the above application is incorporated herein by reference.

### BACKGROUND

The present invention relates generally to video processing and more particularly to a 3D video processing circuit utilizing gate array technology to implement alpha blending of natively unsynchronized left and right video signals. The circuit allows asynchronous video sources to be combined to provide a real-time 3D display.

In a conventional 3D display system, special synchronized video cameras supply the left and right video channels which are then fed to a 3D display capable of conveying a stereoscopic perception of 3D depth to the viewer. The basic requirement is to present 2D offset images that are displayed separately to the left and right eye. Both of these 2D offset images are then combined in the brain to give the perception of 3D depth. In some systems special eyeglasses are worn by the user to filter the left and right channel information so that each eye receives only video data for the appropriate channel.

Having the left and right cameras synchronized is important if an accurate real-time 3D display is desired. The 3D display depends upon fooling the brain into seeing a 3D scene, when in fact the left and right data streams are merely 2D images, offset from one another to simulate binocular vision. If these two 2D images are not synchronized, the brain may have difficulty making sense of the image, possibly resulting in a blurred or distorted view. Thus current 3D systems employ expensive, synchronized video cameras that are interconnected to share a common synchronizing clock signal.

### SUMMARY

The 3D Video Processing Unit (3D-VPU) of the present disclosure provides a real-time 3D display by combining the signals from two video cameras to generate a video output that can be displayed as a 3D image on any of a variety of specialized video monitors.

Optionally, the 3D-VPU can also accept the digital visual interface (DVI) output from a standard office computer or other video source. This allows the same video monitor to be used for both office computer 2D display and/or the real-time 3D display (either switching between the computer display and real-time 3D display or combining the realtime 3D display with the office computer display).

For any application that uses the video display to provide operator feedback (e.g., heads-up dentistry, opthamalic or endoscopic surgery) it is important to minimize the delay between the camera input and the display output to avoid creating hand-eye coordination problems. The 3D-VPU minimizes this delay by performing the video processing in a streamlined and optimized logic pipeline implemented in a Field Programmable Gate Array (FPGA).

Further, use of an FPGA improves speed and greatly reduces complexity. Reduced complexity means lower failure rate (due to, for example, fewer parts, connections and modules to fail). It enables the addition of signal conditioning, such a sharpening filter, without requiring any changes to the hardware. This permits design flexibility to customize capability to fit various market segments, without the necessity of setting up additional production facilities. Some upgrades can be made in the field when and where as required.

The 3D-VPU uses packet switching to encapsulate each incoming video field. This facilitates the reduction of the video latency and the synchronization of the two video streams by allowing the video processing functions to operate at a clock rate significantly higher than the input/output data rate.

The 3D-VPU can be configured to use either standard-definition or high-definition cameras. It does not require the use of expensive synchronized cameras and it can output to a number of different 3D-capable monitor display technologies.

The 3D-VPU technology can be implemented on a single printed circuit board that is sufficiently small to be included alongside the cameras inside a small Camera/Lamp module. The resulting single compact unit can then be connected directly to the 3D Display to form a complete realtime 3D display system controlled via a remote control unit similar to those used by home entertainment equipment.

Accordingly, the 3D video processing unit, or apparatus, comprises first and second input processing blocks, each receptive of video information from first and second video data sources. The video data sources may be asynchronous. First and second frame buffers receive, organize and store the first and second video data as buffered data. First and second alpha data generators, coupled to the frame buffers, inspect the buffered data on a pixel-by-pixel basis to generate and associate an alpha data value with each pixel. An alpha blending mixer, receptive of the buffered first and second video data and the associated alpha data values then combines the buffered data into a single video output data according to a predefined 3D encoding format. A video output processing block (or circuit) coupled to the alpha blending mixer supplies the output data as clocked video output for display on a monitor.

### BRIEF DESCRIPTION OF THE DRAWINGS

FIG. 1 is a block diagram of an embodiment of the 3D video processing unit (3D-VPU);

FIG. 2 is an expanded perspective diagrammatic view showing the alpha blending process and showing how a portion of the background layer is selectively made visible;

FIG. 3 is a process flow diagram useful in understanding the operation of the 3D video processing unit (3D-VPU);

FIGS. 4a and 4b (collectively FIG. 4) are a block diagram of the alpha generator;

FIG. 5 is a process flow diagram depicting the mode-driven alpha data generation process;

FIG. 6 is a table showing various graphical representations illustrating how the alpha data generation process operates to control the alpha blending mixer to generate 3D images for different types of display monitors and display devices.

### DESCRIPTION OF THE PREFERRED EMBODIMENTS

By way of introduction, creating a 3D display from a left and right video input involves the following three general processes:
1. Convert the input signal format to the format required by the display device;
2. Synchronize the two input signals;
3. Combine the two input signals into a single output signal suitable for the selected display device.

The 3D-video processing unit described here performs each of these general processes, as will now be more fully explained.

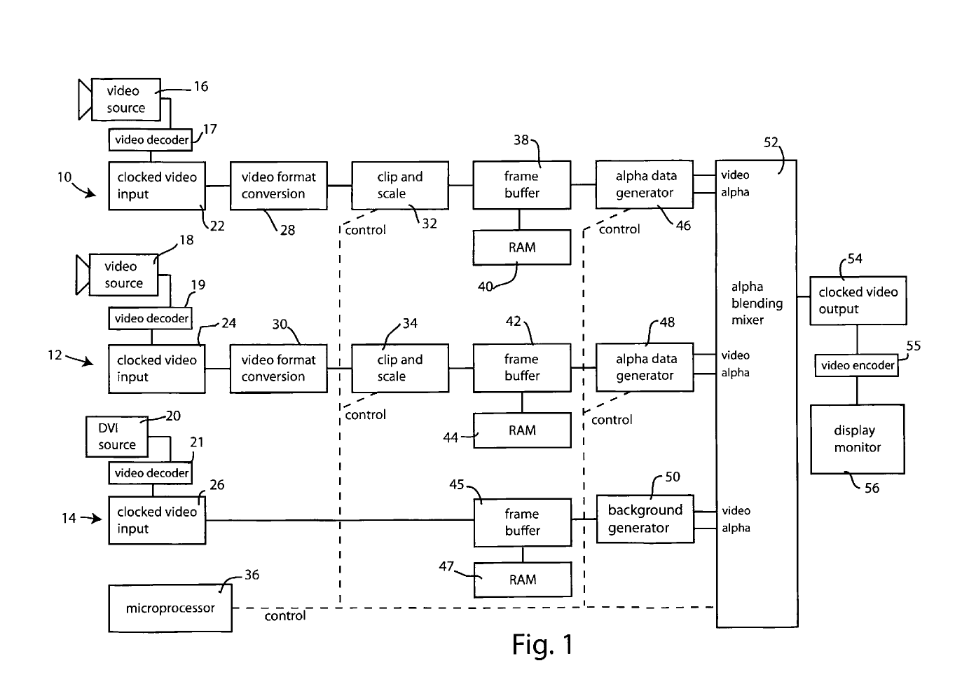

Referring to FIG. 1, the 3D-video processing unit (3D-VPU) has a left video channel 10, a right video channel 12 and an auxiliary channel 14. Throughout this description, it will be understood that the auxiliary channel 14 and the components used to implement it are optional, in the sense that if the auxiliary channel is not required for a particular application, that channel can be omitted or disabled in the circuit. It should also be understood that the video sources can be of a variety of different formats, analog or digital, depending on the particular embodiment. Thus, by way of example, the 3D-VPU can be configured to use either standard-definition (SD) video cameras (e.g., 480i) or high-definition video cameras (HD) (e.g., 720p or 1080i) using any standard interface, such as analog composite (CVBS), S-video, analog component, or digital component.

In order to generate a 3D display from two real-time video inputs the 3D-VPU must perform these basic tasks:
1. Convert the format of the video inputs to be compatible with the output display device.
2. Offset and clip each video stream to compensate for the camera offset.
3. Synchronize the two video input streams.
4. Create a video output stream by selecting each pixel from the appropriate input stream (the selection process depends upon the type of output display, as discussed will be discussed below).

The presently preferred embodiments perform these tasks with the aid of a field programmable gate array (FPGA) device, configured as described herein. Of course other signal processing circuitry may be used instead.

In the embodiment illustrated in FIG. 1, the left and right channels are coupled, respectively, to video sources 16 and 18, which may be video cameras. The auxiliary channel 14 is coupled to an auxiliary video data source such as a digital video (DVI) source 20. Note that the respective video sources, 16, 18 and 20 are asynchronous; that is, each source has its own clock and each source operates independently of the other sources. The video sources 16 and 18 may be either analog or digital. If analog cameras are employed, certain signal preprocessing is employed, to transform the video data into the digital domain for further processing by the circuits described herein.

Having the ability to work with asynchronous video sources is one important benefit, which allows lower cost video cameras to be used. As will be more fully explained herein, the respective video sources are processed through a sequence of processing blocks or circuits, essentially in parallel and independent from one another until finally being synchronized by the circuitry of the 3D-VPU just prior to an alpha blending process performed by the alpha blending mixer 52.

The respective video sources 16, 18 and 20 are first processed by the suitable video decoder circuits 17, 19 and 21, respectively. These circuits provide a suitable physical interface to the video source device and function primarily to convert the video input signal from analog to digital, if necessary, and to provide local synchronism with the frame rate of the video source. In the embodiment illustrated in FIG. 1, video decoder circuits 17 and 19 are adapted to receive video data from video camera sources 16 and 18. The video decoder circuit 21 is adapted to receive digital video from a DVI source 20. Of course, different applications may require different types of video sources and hence different types of video decoder circuits or other input processing circuits.

When using analog cameras for video sources 16 and 18 the video decoder circuits 17 and 19 decode the analog input signal into a digital data stream containing the video pixel data, along with its associated horizontal sync, vertical sync, and clock signals. This is typically done using a standard video decoder integrated circuit, such as a TVP5154 device available from Texas Instruments.

When using digital cameras, such as DVI-D or HDMI, for video sources 16 and 18 the video decoder circuits 17 and 19 convert the digital input into a standard clocked video format. For example, when using cameras with DVI-D output the video decoder converts the transition minimized differential signaling (TMDS) data from the camera into a standard clocked video data stream containing the video pixel data, along with its associated horizontal sync, vertical sync, and clock signals. This is typically done using a standard digital receiver integrated circuit, such as the TFP401 device available from Texas Instruments.

The optional video source 20 would typically be a DVI-D computer display output. In this case the video decoder circuit 21 would use a standard digital receiver integrated circuit, such as the TFP401 device available from Texas Instruments.

The digital video data input via the respective video decoder circuits undergo additional processing before they can be combined into a 3D image within the alpha blending mixer 52. In a presently preferred embodiment this additional processing and alpha blending mixing is performed using a field programmable gate array (FPGA) device, such as the Cyclone III available from Altera Devices. Other FPGA devices may be used, such those as from Xilinx, Inc. In a presently preferred embodiment, all of the processing blocks illustrated in FIG. 1 may be implemented using field programmable gate array technology (FPGA), except for the video decoder circuits, video encoder circuit 55, display monitor 56 and the RAM.

More specifically, the outputs of respective video decoder circuits are clocked into the FPGA device via clocked video input circuits 22, 24 and 26, defined by the FPGA device. The clocked video input circuits convert the incoming video data into a packetized format by extracting the video and associated synchronization data from the incoming data stream and generating a packetized output data stream. In this way the video data are thus converted to a format suitable for processing within the FPGA device. In this regard, a typical FPGA device operates upon the video data that have been packetized according to a predefined streaming interface specification. The Altera Cyclone III device used for this example utilizes a streaming interface known as Avalon-ST.

After inputting the video data into the FPGA device, the data originating from video sources (cameras) 16 and 18 are fed to respective video format conversion blocks or circuits 28 and 30, also defined by the FPGA device. For the illustrated example, it is assumed that the video data originating from DVI source 20 does not require format conversion; hence a format conversion block for that channel has not been shown.

The video format conversion blocks or circuits 28 and 30 convert the digitized data to the format used by the output display monitor (typically RGB 4:4:4 progressive format). This can include any or all of the following steps, depending upon the incoming data format:
Chroma resampling
Color space conversion
Deinterlacing

More specifically, for a video source that provides video in interlaced format using the YCrCb 4:2:2 color space, such as standard-definition (480i) video cameras, and an output display that uses the RGB 4:4:4 progressive video format, the video format conversion blocks 28 and 30 convert the format by first expanding the color difference components (Cb and Cr) to a higher bandwidth of YCrCb 4:4:4 format. The YCrCb color space is then converted to an RGB color space, converting the video to RGB 4:4:4 format, and then the image is deinterlaced.

After video format conversion, the digital video data are processed by clip and scale operations in the processing blocks or circuits 32 and 34 based on a control signal from microprocessor 36. The clip and scale circuits first clip the incoming video to select a desired portion of the video image for display and then scale it to the final display size for the monitor. The settings for the clipping and scaling functions can be varied in real-time by the microprocessor 36. The clip and scale operation provides the following features:
Removes pixels that are not visible by both left and right cameras
Allows the user to adjust the lateral offset of the left and right images on the display to minimize eye strain when viewing the 3D image
Allows the user to zoom into a selected portion of the input video (typically called “digital zoom”)
Allows the user to control the size of the 3D image on the monitor, allowing the 3D image to be combined with the optional computer display output.

Preferably, the clipping is adjusted separately for the left and right channels to accommodate the different field of view of the left and right cameras. In this regard, In order to produce a usable 3D display the left and right cameras must be separated horizontally by an amount that is dependent on several factors such as the distance to the subject. The optical axis of the two cameras must be parallel to each other in order to avoid a change in perspective that makes it impossible to merge the two images to produce a 3D image over the entire displayed frame.

The fact that the two cameras are parallel and offset means that they have a slightly different field of view: the leftmost pixels on the left camera are not captured by the right camera and the rightmost pixels on the right camera are not captured on the left camera.

This means that if we simply combine the images from the left and right cameras to form a 3D display the left and right edges of the display will be 2D because they are only provided by one camera.

Also, the lateral offset of the left and right images on the monitor controls the ease of viewing the 3D image. The issue is that when looking at a close object the eyes rotate toward each other (vergence) such that the two axes converge on the object being viewed. Normally the eyes adjust the focus of the eyes (accommodation) to the point where the eyes converge. However, when viewing a 3D image generated by a flat display screen it is necessary for the viewer to adjust the convergence of their eyes to view object that appear to be in front of or behind the screen while still maintaining focus on the screen. This vergence-accommodation conflict can cause significant eye strain.

To remedy these two issues the 3D-VPU adjusts the settings on the clipper to remove any pixels from the left and right video that do not have corresponding pixels from the opposite camera and it adjusts the positions of the left and right video on the display screen horizontally to minimize the vergence-accommodation conflict when viewing the 3D image.

The amount of the horizontal shift can be adjusted in order to make the depth of any portion of the 3D image appear to be at the surface of the display screen (with closer objects appearing to be in front of the display screen and further objects appearing to be behind the display screen).

After the clip and scale operation, the video data are stored by a frame buffering block or circuit 38 and 42 for storage in random access memory (RAM) 40 and 44, respectively. Recall that the RAM memory is typically attached externally to the FPGA device. Also, as illustrated, the video output from the DVI source 20 (channel 14) is also fed to a frame buffering block or circuit 45 with RAM 47 for storage. The frame buffers provide temporary storage of the video frames in RAM to allow the synchronization of the two video streams as the video packets are fed into the following stages.

Coupled to the frame buffer circuits 38 and 42 are the alpha data generator circuits or blocks 46 and 48, respectively. These circuits monitor and evaluate the data stored in the respective frame buffers and generate additional alpha data values, on a pixel-by-pixel basis, according to the state of the data in the buffers. These alpha data values control how/whether the associated pixels are expressed in the blended 3D video output as will be described.

The alpha data generator circuits create a data stream that contains ‘alpha’ data for each display pixel. This ‘alpha’ data controls whether or not a given pixel will be included in the output data stream. Each alpha data generator is programmed by the microprocessor to select the appropriate alpha pattern depending upon the display device (e.g., row interlaced, column interlaced, or quincunx interlaced) and display mode. The alpha data generators can be programmed to set up any of the following display modes:
Display 3D video.
Display only the left or right video on all pixels. This allows the display to be used to display a 2D video input from either the left or right camera.
Display only the background (computer monitor output). This allows the display to be used as a conventional computer monitor.

The video data stored in the framed buffers are packetized and thus structured to include a header block, containing certain metadata information, and a data block, containing the video data, pixel-by-pixel. The alpha data generator circuits monitor this header information to detect when the entire video data frame is present in the frame buffer. Because the left and right video channels are (up to this point) operating asynchronously, the frame buffers may not necessarily each become fully populated at the same instant. Thus, the system monitors the status of each frame buffer to detect when all contain a complete frame of video data.

When all buffers contain a start-of-frame indicia, the alpha data generator circuits 46 and 48 pull the data from the respective frame buffers, generate associated alpha data values with the video data, on a pixel-by-pixel basis and supply the video data and alpha data values (as pixel-by-pixel ordered pairs) to the alpha blending mixer 52. As will be more fully explained below, the alpha data generator circuits inspect the buffered video data on a pixel-by-pixel basis and generate associated data values for each pixel based on a predefined 3D encoding format selected by the microprocessor 36 via a control signal to the alpha data generator circuits. These alpha data values, in essence, instruct the alpha blending mixer 52 whether a given pixel on the monitor will be from the left or right video input, thus interlacing the left and right images into a single video image. By suitably interlacing the left and right images the resultant image can be viewed as a 3D image when viewed on an appropriate 3D monitor.

The alpha blending mixer 52 combines the left and right video with a background image that can either be a fixed image generated by the FPGA or the image from a computer monitor output. The alpha blending mixer performs the following functions:
Synchronizes all of the inputs (using handshaking on the packetized video input channels to control the data flow);
Combines all inputs using the specified ‘alpha’ values to control which video input is used to generate each pixel of the video output;
Adjusts the position of the left and right video images on the display
It selects which inputs are visible at any given time. This allows the unit to be set to any of a plurality of different display modes.

With continued reference to FIG. 1, the buffered data from the DVI source video (channel 14), is fed directly to a background generator circuit 50. The background generator 50 supplies RGB video to the alpha blending mixer 52, on a pixel-by-pixel basis together with an assigned alpha data value. Depending on whether the DVI source 20 is included, background generator 50 either generates a fixed background image or buffers the optional computer monitor input for display as the background image.

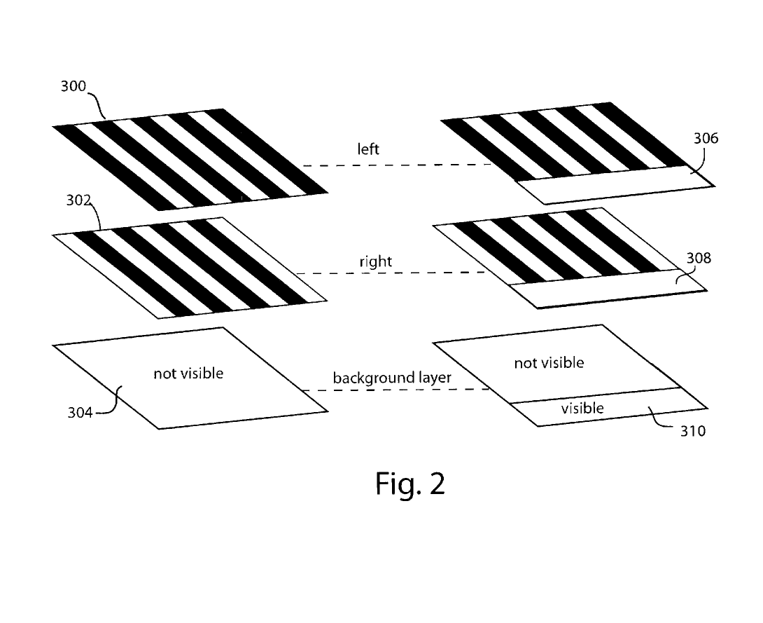

The alpha blending mixer 52 receives data from the left and right channels 10 and 12 and optionally from the DVI channel 14 and blends the data on a pixel-by-pixel basis to define the desired 3D image. The alpha blending mixer treats data coming from the background generator 50 as defining the background layer. Alpha blending is a three layer video blending process, where the background layer lies beneath the left and right channel layers and is thus obscured when either left or right channel layers are expressed. In other words, the left and right video channels are superimposed above the background layer or alpha layer so the user will “see” the data as if viewed from above, looking down through the left channel and right channel layers, and ultimately to the background layer. Thus, if either left channel or right channel alpha values are set to display a particular left or right channel pixel, the background layer pixel will not be visible. Conversely, if both left and right channels are set to suppress their respective pixels at a particular location, then the background pixel will be visible. This is illustrated in greater detail in FIG. 2, which shows the left, right and background layers in exploded perspective view.

In the left-hand side of FIG. 2, the left and right layers 300 and 302 completely obscure the background layer 304 from view. On the right-hand side of FIG. 2, by comparison, the left and right layers have certain pixels shown at 306 and 308, respectively, that are turned off to allow portion 310 of the background layer to be visible. Thus any image or text displayed in portion 310 would be viewable on the display monitor. This allows computer-generated text or graphical images to be displayed on a portion of the display monitor while a 3D image is shown on the remainder.

The 3D-VPU can be configured to use any monitor that is capable of producing a display such that the viewer only sees specific pixels with their left and right eyes. One example is the Hyundai W220S, which uses polarizing filters arranged such that even-numbered lines on the display are seen only by the viewer's right eye and odd-numbered lines on the display are seen only by the viewer's left eye when the viewer wears the appropriate passive polarized glasses. In this case the 3D-VPU is configured to generate an output image using the right video input for the even numbered lines and the left video input for the odd numbered lines.

Other examples of compatible displays are the Mitsubishi WD-57833 or Acer X1130P. These displays are based on the DLP projection system. Due to the nature of the DLP mirror array used in the projection system they display each video frame using two interleaved fields. The first field displays every other pixel of the video frame arranged in the checkerboard pattern of the DLP mirror array. The second field displays the remaining pixels of the video frame in an opposing checkerboard pattern. For 3D display these display units control active shutter glasses such that the first field is seen only by one eye and the second field is seen only by the other eye. In this case the 3D-VPU is configured to generate an output image using the right video input for the pixels in one DLP field and the left video input for the pixels in the other DLP field.

Another example of a compatible display is an autostereoscopic LCD display. This type of display typically uses a lenticular screen in front of an LCD screen to direct the light from even and odd columns to the left and right eyes respectively. Unlike the other displays this type of display does not require the use of glasses since the lenticular screen on the display performs the separation of the images for the left and right eyes. In this case the 3D-VPU is configured to generate an output image using the right video input for the pixels in the odd columns and the left video input for the pixels in the even columns.

The 3D-VPU can also be used to generate 3D images on any 3D-capable television that supports the HDMI version 1.4a 3D video formats, as detailed in Appendix C below.

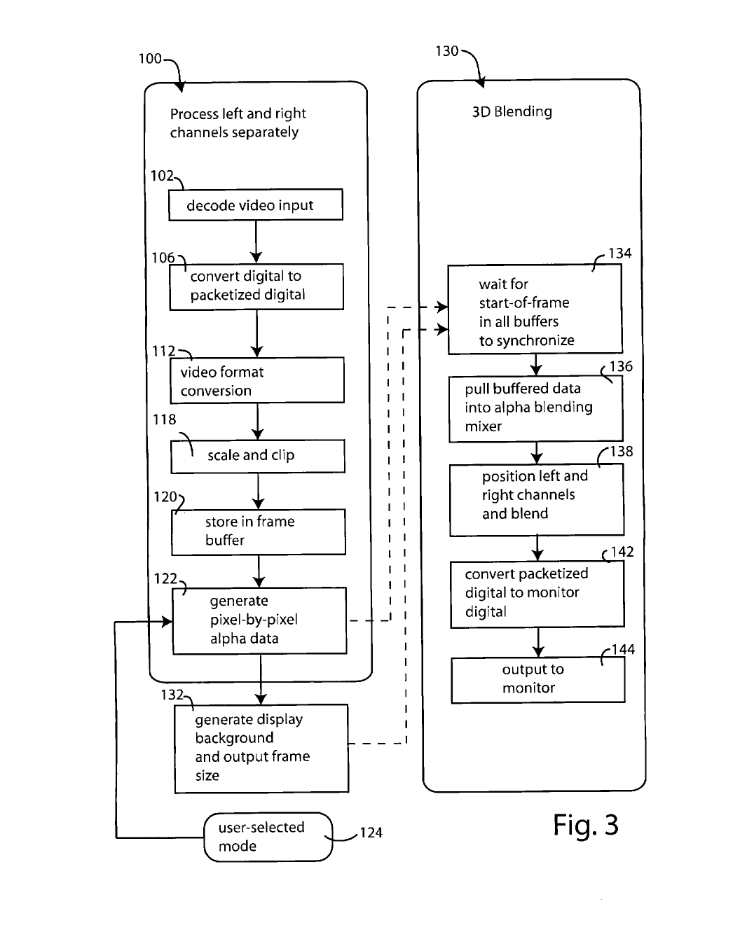

FIG. 3 depicts the processing steps performed by the FPGA and supporting circuits of FIG. 1. For convenience, the steps depicted at 100 correspond to processing steps that are performed on the left, right and optional background channels separately, that is, in parallel. The steps shown generally at 130 are performed on the blended combination of the left and right channels collectively. Thus, the process steps 100 represent asynchronous, parallel operations performed separately on the left and right channels (and background channel if present) whereas the steps 130 represent post-synchronization 3D processing steps.

Referring first to the processing steps 100, the video input signal is decoded at step 102. If the video input signal is an analog video input, the decoding process includes a step (not shown) of converting the analog signal to digital. The decoding step 102 is performed on each channel separately, using an appropriate the video decoder circuit for the type of input received (e.g. circuits 17, 19 and 21 of FIG. 1). Next, at step 106, the video data are converted from digital data in a standard format such as ITU-R BT r656 into the Avalon-ST format. Step 106 is performed by the clocked video input circuits 22, 24 and 26 (if background channel is implemented), resulting in packetized data according to the predetermined format utilized by the field programmable gate array (FPGA) device. The packetized data are then converted at step 112 to effect video format conversion. Step 112 is performed in the video format conversion circuits 28 and 30 (FIG. 1). In the embodiment illustrated in FIG. 1, the background video source supplied by DVI source 20 is already in the proper format. Thus format conversion is not required for the background channel in this embodiment.

Based on control signals from microprocessor 36 (FIG. 1), the scale and clipping operation is next performed at step 118. If, for example, the user has selected a certain region of the image for magnified display, the selected region would be scaled up to full screen size, or other suitable size, with the remainder of the image being cropped or clipped.

The ability to control the position and scaling of the left and right images is important when implementing a 3D picture-in-picture display over a background image, or when implementing the video output format needed for HDMI 3D television monitors. Thus the scale and clip step 118 provides the ability to adjust the size and position of the images from the two cameras to compensate for the offset between the two camera axes and to set the apparent position of the 3D image. Lateral offset adjustment is used to compensate for the lateral offset between the two optical paths and can be used to control the apparent position of the 3D image relative to the plane of the monitor. This setting can be varied by the user, if desired, in order to minimize eye strain. Moreover, vertical offset adjustment may be used to compensate for mechanical offsets between the two optical paths.

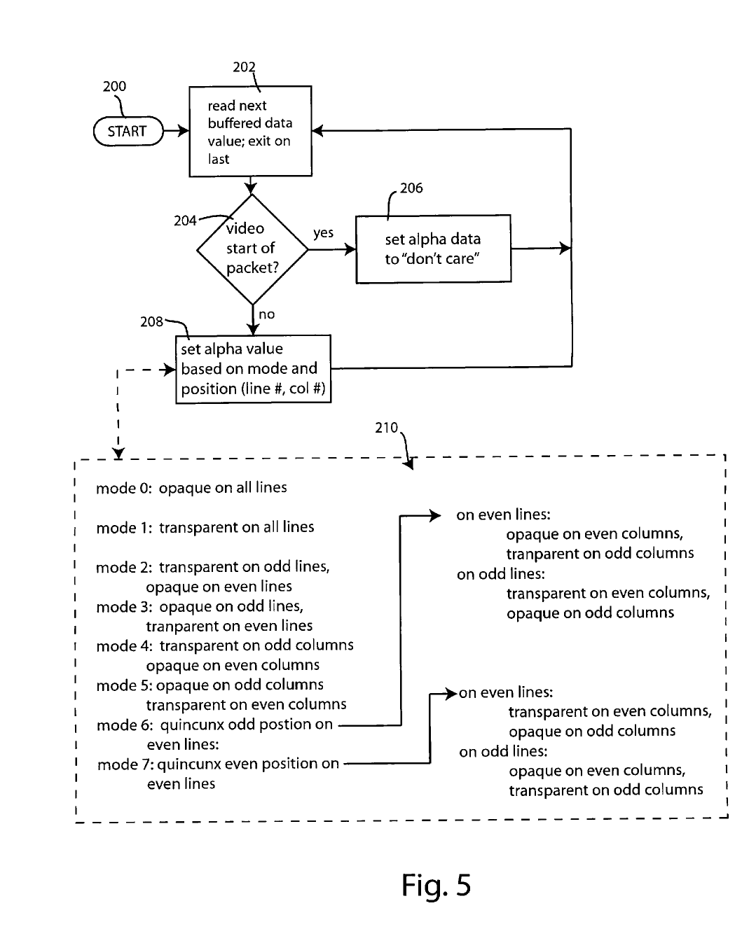

After processing in this fashion, the data for the left, right and optional background channels are separately stored in their respective frame buffers at step 120. Because the data are expressed in a packetized form, the data stored in the frame buffer includes a header block containing certain metadata, including a start-of-frame indicia and a data block containing the digital RGB pixel values for that frame. At step 122, an alpha data value is generated for each pixel of the given frame. As illustrated at 124, this alpha data generated step is performed in accordance with a user-selected mode. The user-selected modes will be discussed more fully in connection with FIG. 5 below.

Synchronizing Video Signals

Before two video signals can be combined by the alpha blending mixer they must be synchronized. In the preferred embodiments this is done by using video frame buffers that buffer the incoming video frames from both input sources in RAM.

The frame buffers have two independent components:
a frame writer that writes to RAM as the video frames are received.
a frame reader that reads the video frames from RAM as they are needed by the following mixer stage.

By using triple-buffering the system is able to decouple the input and output video frame timing. At any given time, the frame writer is writing to one buffer and the frame reader is reading from a previously written buffer. The presence of the third buffer allows the writer and reader to swap buffers asynchronously, allowing the timing between the channels to vary by up to one frame without losing any video frames. If the timing difference between the two channels exceeds one frame then either the reader is allowed to repeat a previous frame, or the writer is allowed to drop a frame, as needed in order to maintain synchronization between the two channels.

The process of buffering the video frames is greatly simplified by the fact that the input stage formats the video data into a packetized format (Avalon-ST video format). Each video frame is sent as a separate packet that includes the frames size and format. For example, packetizing allows the frame buffer to easily deal with video zoom functions, in real time, that change in the video frame size.

Combining Video Signals

In the presently preferred embodiments the alpha-blending mixer stage and the associated programmable alpha data generator logic merge the two video input streams into a single video output stream. This stage combines the two video signals frame-by-frame, adjusting the visibility of each pixel according to the data generated by the alpha generator logic stages.

In the example configuration described in Appendix A, the mixer is configured to layer the left channel frame on top of the right channel frame. Then, for specified pixels in the left frame, the alpha generator logic generates a value that makes that pixel transparent such that the pixel immediately below, in the right frame, becomes visible. The key logic functionality is described in Appendix B.

The alpha generator logic and the scaler and clipper stages can be programmed to generate video formats to support all popular 3D display devices. The 3D-VPU setups for typical 3D displays are described in Appendix C.

In this embodiment the background channel or background layer is treated somewhat differently from the left and right channels. Thus at step 132 a background display is generated. This step also defines the output frame size. The background is generated based on the video data supplied from the DVI source 20 (FIG. 1) if present. If not present, the background may be generated based on a predefined background pattern, such as a single color background, a white background or a black background. As explained above, the background layer may be visible if the left and right video channels are suppressed.

Turning now to the 3D blending steps 130, the previously separate left, right and background channels are synchronized and merged as will now be described.

At step 134, the process waits until all frame buffers (left, right and background, if implemented) contain the start-of-frame indicia. As illustrated by the dashed line, this decision is made by inspecting the header information stored within each frame buffer (step 120). Once all frame buffers contain start-of-frame indicia, the RGB frame data are pulled at step 136 from the respective frame buffers. It is at this point that the left, right and optional background channels become synchronized. Thereafter, at step 138 the left and right channels are positioned over the background layer and blended by the alpha blending mixer 52 (FIG. 1), using the alpha data values generated at step 122 for each pixel. The alpha data values impose a predefined 3D encoding format upon the left and right channels, so that the video information ultimately displayed to the user will be different for the left eye and the right eye.

The alpha blending mixer 52 (FIG. 1) will blend video data optionally supplied from DVI source 20 (FIG. 1), so that it is selectively visible on the display monitor. This is accomplished based on the alpha data values generated at step 122. The background layer, or a portion thereof, is made visible by suppressing both left and right pixels situated above the background layer portion to be made visible. Thus, was discussed and illustrated in connection with FIG. 2, where a selected region of the background layer at 310 was exposed to display video information such as from the DVI source 20 (FIG. 1). This is accomplished by assigning appropriate alpha data values to pixels corresponding to the region of the background layer desired to be made visible. The alpha data values for those pixels of both left and right channels are set to suppress left and right channel information from video sources 16 and 18. This feature may be used, for example, to display computer-generated information such as captions or instructional information on the monitor while at the same time displaying 3D content elsewhere on the monitor.

After the blending step 138 the blended data are then converted from the packetized format used by the field programmable gate array device into monitor digital data at step 142 before being output to the display monitor 56 (FIG. 1) at step 144.

FIG. 5 illustrates the alpha data generation process in greater detail. Beginning at step 200, the process starts by accessing the frame buffer and reading the first available data value extant there (step 202). If the data value corresponds to the start of packet header (step 204), then the alpha data value is set to “don't care” (step 206). If the data is not part of the video start of packet (header), then the alpha data value is set (step 208). The value is set based on the mode, illustrated in block 210 and the position (line number, column number). In other words, for each pixel value associated with a given line number and column number, the alpha data value is set to either “opaque” or “transparent”. When set to “opaque”, a pixel will be displayed; if set to “transparent” the pixel will be suppressed or not displayed.

Block 210 depicts eight modes (mode 0-7) which may be selected based on user-selected mode preferences. The microprocessor 36 (FIG. 1) administers the user-selected mode preference by setting a mode value based on user input through a suitable user interface coupled to the microprocessor. Thus the process at step 208 reads the user selected mode value fed to the alpha data generator by the microprocessor 36 (FIG. 1).

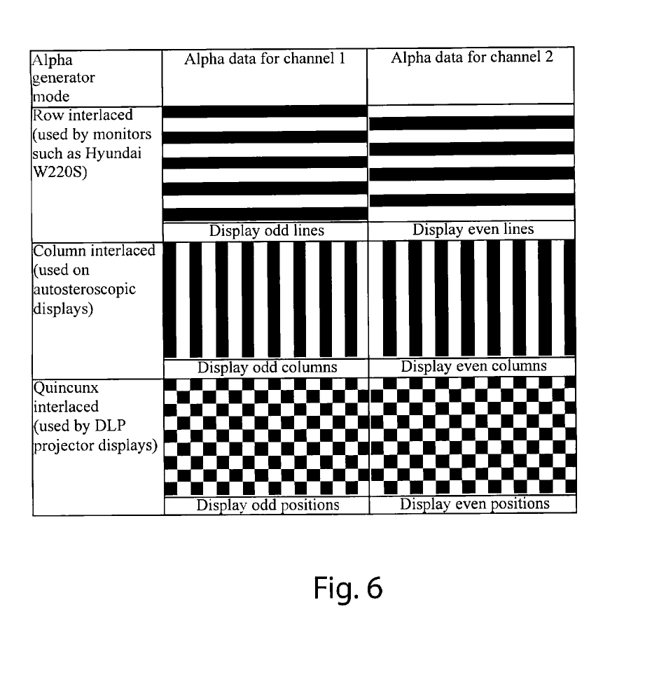

The process continues until all of the data within the frame buffer has been processed and a suitable alpha data value is assigned to each pixel. FIG. 6 shows some examples of how the alpha data values would be assigned to the left and right channels (channels 1 and 2) to achieve a particular alpha generator mode. Specifically shown is a row-interlaced mode, suitable for use with monitors such as the Hyundai W220S. Also shown is a column-interlaced mode, suitable for use on autosteroscopic displays. A Quincunx-interlaced mode, suitable for use by DLP projector displays is also shown.

Hand-Eye Coordination when Using 3D Realtime Display

For optimum hand-eye coordination the two cameras in the 3D display system are generally positioned such that the baseline between the cameras is parallel to the baseline between the viewer's eyes. This makes left/right motions in the camera's field of view display as matching motions on the 3D display. (If the camera baseline is not parallel to the viewer's eyes then left/right motions will produce motions at an angle on the 3D display, making it difficult to maintain hand/eye coordination.) If it is necessary to position the cameras such that they are pointing generally back toward the user there are two possible options:
1. Rotate the camera assembly about a horizontal axis parallel to the baseline between the cameras (keeping the left camera on the user's left side and the right camera on the user's right side). In this case the images from the two cameras are inverted because both cameras are upside-down. In this case left/right motions will produce corresponding left/right motions on the 3D display, but up/down motions will be reversed because the cameras are inverted. In this case it is desirable to flip the image vertically in order to maintain correlation between both left/right and up/down directions as perceived by the user. This can be done by reprogramming the frame buffer stages to read the lines of each image out in reverse order.
2. Rotate the camera assembly about their vertical axis. This keeps the cameras right-side-up, but it reverses the left/right camera positions relative to the user (putting the ‘left’ camera on the user's right side and the ‘right’ camera on the user's left side). In this case the images from the two cameras are right-side-up but left/right motions produce opposite motions on the display due to the camera's horizontal rotation. Also, depth perception is affected since the image from the camera on the user's left side is seen by the user's right eye and visa versa. In this case it is desirable to perform two modifications to the image processing:
a. Flip the image horizontally in order to maintain correct left/right orientation on the 3D display. This is done by reprogramming the frame buffer such that it reads the lines of the image in the normal order, but it reads the pixels within each line out in reverse order.
b. Swap the left/right image paths between the cameras and the display output so that the image from the camera on the user's right is seen by the user's right eye and the image from the camera on the user's left is seen by the user's left eye. This is done by reprogramming the alpha generator logic.

In either case the end result is that the image on the 3D display appears the same as an image in a mirror, with left/right and up/down orientations preserved.

From the foregoing it will be appreciated that the 3D-VPU advantageously uses the video alpha blending mixer to combine the video inputs from two video sources (typically a pair of video cameras) into a single 3D video output for 3D-capable displays. This is done in real-time while minimizing delays. If desired, the 3D-VPU may use a programmable alpha blending mixer along with programmable video scalers and alpha data generators to achieve flexibility. By modifying the settings on the blender, scaler, and alpha generator stages, this one processing unit is able to generate the appropriate video output formats for many popular 3D display devices, including:
Line-interlaced displays (e.g., Hyundai W220S LCD monitor)
Column-interlaced displays (e.g., autostereoscopic displays)
Quincunx matrix interlaced displays (e.g., DLP projectors)
3D television displays using new HDMI 3D video formats (e.g., frame packing, side-by-side, and top-and-bottom video signal formats as specified in the HDMI version 1.4a specification)

From the foregoing it will also be appreciated that by utilizing packetization of the video frames, the 3D-VPU can significantly simplify the synchronization of the video signals from two (typically low cost) unsynchronized video sources and also permits real time frame-by-frame modifications of the signal downstream.

Appendix A—FPGA Video Configuration for NTSC Analog Inputs

The diagram of FIG. 1 illustrates the FPGA configuration of the video processing functions when using two standard definition NTSC analog inputs.

In this configuration each of the two video inputs is processed as follows:
The analog video input is converted to a BT-656 digital data stream by the ‘video decoder’ stage. At this point the data stream contains video data along with horizontal and vertical sync and blanking information.
The digital BT-656 data is converted to Avalon-ST video packet format by the ‘clocked video input’ stage. At this point the data stream consists of packets with headers describing the video frame size and format and the video data in YCrCb 4:2:2 format.
The ‘video format conversion’ converts the interlaced YCrCb 4:2:2 data to progressive RGB 4:4:4 data by performing the following steps:
   A clipper stage removes extraneous lines from the input video fields.
   A color plane sequencer converts the pixel data format from sequential to parallel format
   A chroma resampler converts the pixel format from YCrCb 4:2:2 to YCrCb 4:4:4 format
   A color space converter converts the pixel format from YCrCb 4:4:4 to RGB 4:4:4
   An deinterlacer converts each frame from interlaced to progressive format. At this point the frame is progressive RGB 4:4:4 format.
The ‘clip and scale’ stage first clips the left edge of the left video frame and the right edge of the right video frame to eliminate pixels that are not present in both images, then it scales the video to its final video display size
The frame buffers provide buffering to allow synchronization of the two video streams
The alpha generators provide the transparency data on a pixel by pixel basis for each layer
The test pattern generator creates the display background and establishes the output frame size.
The alpha blending mixer positions and combines the video layers into a single video output.
The clocked video output converts from the Avalon-ST video packet format to the monitor output format, in this case DVI.

Appendix B—Alpha Generator Logic

The alpha generator logic consists of two components: one to decode the Avalon-ST video packet header and data fields and a second component to generate the alpha data based upon the video data and the user-specified operating mode.

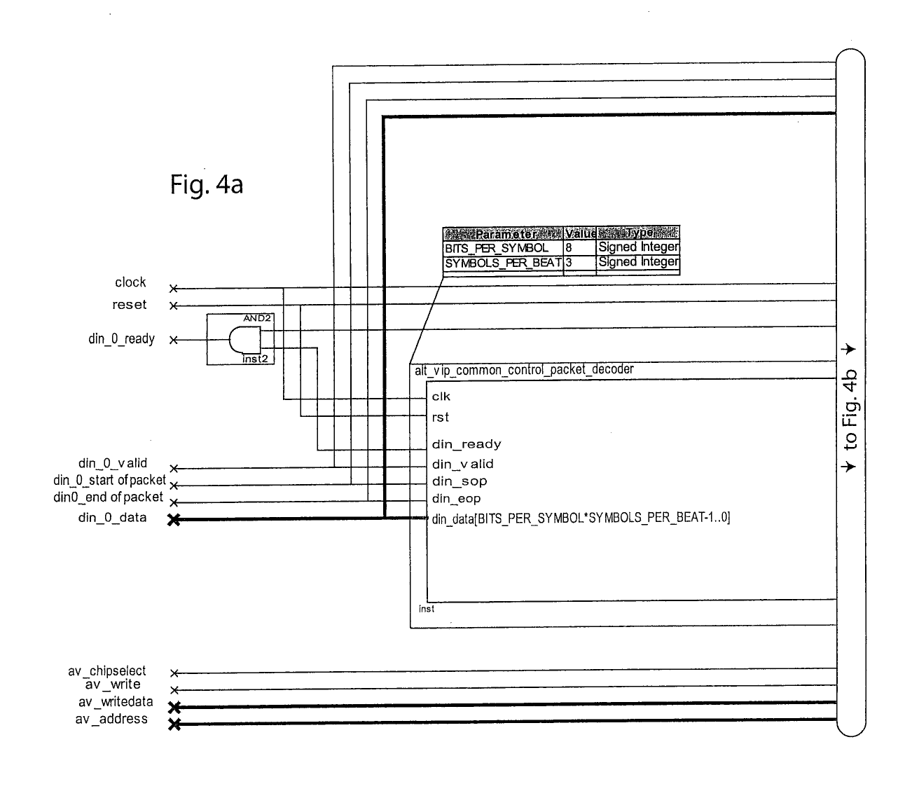

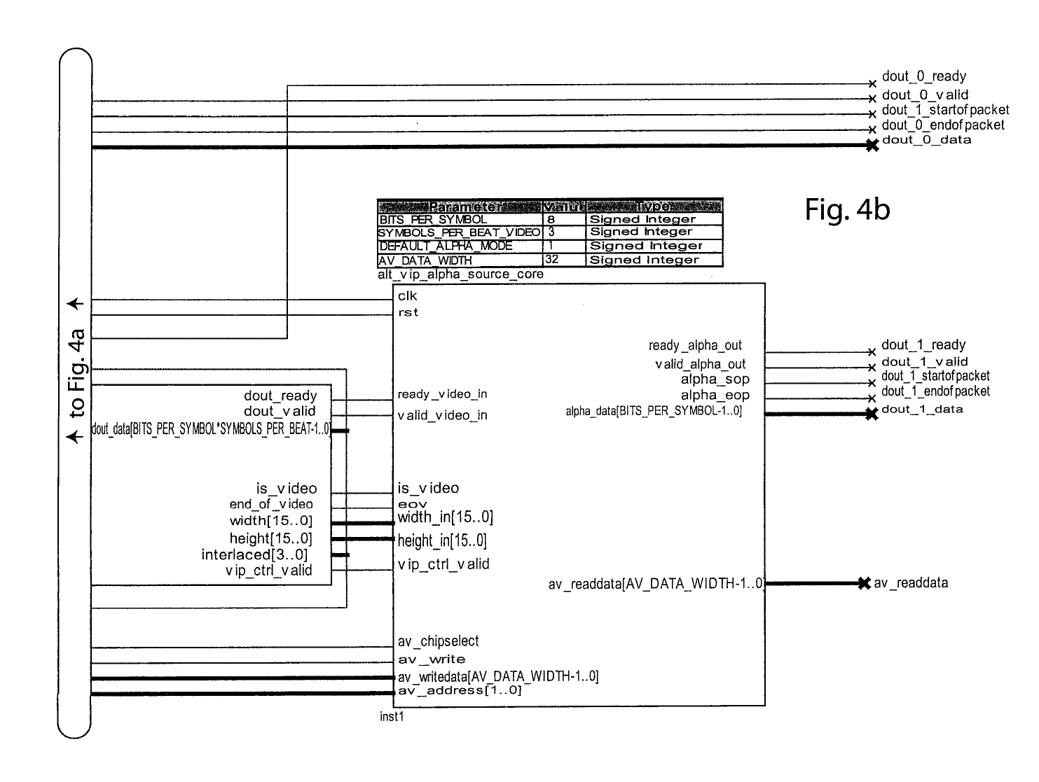

The overall structure of the alpha generator is illustrated in the block diagram in FIGS. 4a and 4b.

The first functional block (alt_vip_common_control_packet_decoder) decodes the Avalon-ST video packet header and generates logic values that indicate width and height of the current video frame along with appropriate handshake signals.

The second functional block (alt_vip_alpha_source_core) generates the alpha data output based upon the incoming video data and the user-specified operating mode (which is set via the Avalon memory mapped interface by the on-chip Nios II CPU).

The alpha source core logic uses an internal state machine to determine when the incoming data represents the active video data and then generates the alpha data using the following Verilog code fragment:

if (state[1]) begin

| // Video ID byte | |
|---|---|
| alpha_sop <= 1′b1; | // set ‘start of packet’ = 1 |
| alpha_data <= 0; | // alpha data = don’t care |

end else begin

| // Video data | |
|---|---|
| alpha_sop <= 1′b0; | // set ‘start of packet’ = 0 |

| | |
|---|---|
| // | set alpha value based upon mode and position: line number ‘count_h’ and column number |

‘count_w’

case (alpha_mode)

3′b000 : begin

| | |
|---|---|
| alpha_data <= 8′b00000000; | // mode 0: opaque on all lines |

end

3′b001 : begin

| | |
|---|---|
| alpha_data <= 8′b11111111; | // mode 1: transparent on all lines |

end

3′b010 : begin

if (count_h[0]) begin

| | |
|---|---|
| alpha_data <= 8′b11111111; | // mode 2: transparent on odd lines, and |

end else begin

| | | |
|---|---|---|
| alpha_data <= 8′b00000000; | // | opaque on even lines |

end

end

3′b011 : begin

if (count_h[0]) begin

| | |
|---|---|
| alpha_data <= 8′b00000000; | // mode 3: opaque on odd lines, and |

end else begin

| | | |
|---|---|---|
| alpha_data <= 8′b11111111; | // | transparent on even lines |

end

end

3′b100 : begin

if (count_w[0]) begin

| | |
|---|---|
| alpha_data <= 8′b11111111; | // mode 4: transparent on odd columns, and |

end else begin

| | | |
|---|---|---|
| alpha data <= 8′b00000000; | // | opaque on even columns |

end

end

3′b101 : begin

if (count_w[0]) begin

| | |
|---|---|
| alpha_data <= 8′b00000000; | // mode 5: opaque on odd columns, and |

end else begin

| | | |
|---|---|---|
| alpha data <= 8′b11111111; | // | transparent on even columns |

end

end

| | |
|---|---|
| 3′b110 : begin | // mode 6: quincunx odd position |

| | | |
|---|---|---|
| if (count_h[0]) begin | // | on even lines: |

if (count_w[0])

| | | |
|---|---|---|
| alpha_data <= 8′b00000000; | // | opaque on even columns, and |

else

| | | |
|---|---|---|
| alpha_data <= 8′b11111111; | // | transparent on odd columns |

end

| | | |
|---|---|---|
| end else begin | // | on odd lines: |

if (count_w[0])

| | | |
|---|---|---|
| alpha_data <= 8′b11111111; | // | transparent on even columns, |

and

else

| | | |
|---|---|---|
| alpha_data <= 8′b00000000; | // | opaque on odd columns |

end

end

| | |
|---|---|
| 3′b111 : begin | // mode 7: quincunx even position |

| | | |
|---|---|---|
| if (count_h[0]) begin | // | on even lines: |

if (count_w[0])

| | | |
|---|---|---|
| alpha data <= 8′b11111111; | // | transparent on even columns, |

and

else

| | | |
|---|---|---|
| alpha_data <= 8′b00000000; | // | opaque on odd columns |

end

| | | |
|---|---|---|
| end else begin | // | on odd lines: |

if (count_w[0])

| | | |
|---|---|---|
| alpha_data <= 8′b00000000; | // | opaque on even columns, and |

else

| | | |
|---|---|---|
| alpha_data <= 8′b11111111; | // | transparent on odd columns |

end

end

endcase

end

Appendix C—3D-VPU Setups for Typical 3D Monitors

Line-Interlaced

Displays like the Hyundai W220S LCD monitor use the line-interlaced 3D format. The viewer must wear special passive polarized glasses to view the 3D image. (For reference, the glasses handed out in theaters to view the movie Avatar, use the same technology.)

In the line-interlaced 3D format, the light emitted from the display is polarized such that, with these special glasses, the even numbered lines are seen only by the right eye and the odd numbered lines are seen only by the left eye.

For a line-interlaced display the 3D-VPU unit is configured as follows:
The left and right images are scaled to the desired display size.
The output frame is set to the desired display size.
The left and right images are positioned on top of each other using the mixer position controls.
The alpha generator for the right video channel is configured to mode 2 (opaque on even lines, transparent on odd lines).
The alpha generator for the left video channel is configured to mode 3 (opaque on odd lines, transparent on even lines)

Column-Interlaced

Auto stereographic displays use a lenticular lens to direct the light from alternating columns of the display to the left and right eyes. This has the advantage of not requiring special glasses to view the 3D image, but generally only provides a narrow viewing angle.

For example, with one display technology, the even numbered columns are seen only by the left eye and the odd numbered columns are seen only by the right eye when the viewer is positioned directly in front of the screen.

The 3D-VPU setup for the column-interlaced display is similar to that for the line-interlaced mode except for the alpha generator settings.

For a column-interlaced display the 3D-VPU is configured as follows:
The left and right images are scaled to the desired display size
The output frame is set to the desired display size
The left and right images are positioned on top of each other using the mixer position controls
The alpha generator for the right video channel is configured to mode 4 (opaque on even columns, transparent on odd columns)
The alpha generator for the left video channel is configured to mode 5 (opaque on odd columns, transparent on even columns)

Quincunx Matrix-Interlaced

DLP-based projection systems display each video frame using two interleaved fields. The first field displays every other pixel of the video frame arranged in the quincunx (‘checkerboard’) pattern of the DLP mirror array. The second field displays the remaining pixels of the video frame in the opposing quincunx pattern. To achieve 3D display, these display units control active shutter glasses such that the first field is seen only by one eye and the second field is seen only by the other eye.

In the following example, the ‘odd position’ field is seen only by the left eye and the ‘even position’ field is seen only by the right eye when the viewer is wearing the active shutter glasses.

The 3D-VPU setup for the quincunx matrix-interlaced display is similar to that for the line-interlaced mode except for the alpha generator settings.

For a quincunx matrix-interlaced display the 3D-VPU is configured as follows:
The left and right images are scaled to the desired display size
The output frame is set to the desired display size
The left and right images are positioned on top of each other using the mixer position controls
The alpha generator for the right video channel is configured to mode 7 (opaque on ‘even position’ quincunx matrix pixels, transparent on ‘odd position’ quincunx matrix pixels)
The alpha generator for the left video channel is configured to mode 6 (opaque on ‘odd position’ quincunx matrix pixels, transparent on ‘even position’ quincunx matrix pixels)

3D Television (HDMI Version 1.4a—3D Formats)

The new 3D televisions can use any of a number of different video formats as described in version 1.4a of the HDMI specification. These include ‘frame packing’, ‘side-by-side’, and ‘top-and-bottom’ formats. In these formats, the left and right video frames are joined together so as to create a single frame that is then sent to the display device.

Current versions of 3D televisions require the use of active shutter glasses. Future versions may use different display technologies, but the format of the video input will remain the same.

The 3D-VPU setup for these displays differs from the previous configurations in that the output video frame size is created by joining the two input frames next to each other rather than interleaving them pixel by pixel. However, this only requires a slight change in the 3D-VPU configuration.

For the ‘frame packing’ format:
The output video frame is the same width but twice the height of the input video frame. The left video frame is positioned at the top of the output frame and the right video frame positioned at the bottom of the output frame.
To generate this video format the 3D-VPU is configured as follows:
   The left and right images are scaled to the desired display size
   The output frame size is set to be twice its normal height.
   The left image is positioned to the top of the output frame using the mixer position controls
   The right image is positioned to the bottom of the output frame using the mixer position controls
   The alpha generator for both the left and right video channels are configured to mode 0 (opaque on all lines)

For ‘side-by-side (half)’ format:
The output video frame is the same height and width as the input video frame. The left video frame is scaled to half its normal width and is positioned on the left side of the output frame. The right video frame is scaled to half its normal width and is positioned on the right side of the output frame.
To generate this video format the 3D-VPU is configured as follows:
   The left and right images are scaled to the desired display height, but only half the desired display width using the scaler controls
   The output frame is set to the desired display size
   The left image is positioned to the left side of the output frame using the mixer position controls
   The right image is positioned to the right side of the output frame using the mixer position controls
   The alpha generator for both the left and right video channels are configured to mode 0 (opaque on all lines)

For ‘top-and-bottom’ format:
The output video frame is the same height and width as the input video frame. The left video frame is scaled to half its normal height and is positioned on the top of the output frame. The right video frame is scaled to half its normal height and is positioned on the bottom of the output frame.
To generate this video format the 3D-VPU is configured as follows:
   The left and right images are scaled to the desired display width, but only half the desired display height using the scaler controls
   The output frame is set to the desired display size
   The left image is positioned to the top of the output frame using the mixer position controls
   The right image is positioned to the bottom of the output frame using the mixer position controls
   The alpha generator for both the left and right video channels are configured to mode 0 (opaque on all lines)

1. A 3D video processing apparatus comprising:
first input processing block receptive of video information from a first source and producing first video data;
first frame buffer coupled to said first input that receives, organizes and stores said first video data as buffered first video data defining at least one frame comprising a plurality of pixels;
first alpha data generator coupled to said first frame buffer and operative to inspect said buffered first video data on a pixel-by-pixel basis to generate and associate with each pixel an alpha data value;
second input processing block receptive of video information from a second source and producing second video data;
second frame buffer coupled to said first input that receives, organizes and stores said second video data as buffered second video data defining at least one frame comprising a plurality of pixels;
second alpha data generator coupled to said first frame buffer and operative to inspect said buffered second video data on a pixel-by-pixel basis to generate and associate with each pixel an alpha data value;
an alpha blending mixer receptive of said buffered first and second video data and the alpha data values associated therewith and operative to combine said first and second buffered video data into a single video output data according to the alpha data values;
a video output processing block coupled to said alpha blending mixer and supplying said output data as a clocked video output for display on a monitor.

2. The apparatus of claim 1 wherein each of said first and second alpha data generators includes a mode select control port and the apparatus further comprises a processor that supplies mode select information to said control ports.

3. The apparatus of claim 1 wherein said first and second alpha data generators each comprise a decoder logic circuit that extracts information from the first and second video data respectively and a data generation circuit that generates alpha data values based on the extracted information.

4. The apparatus of claim 3 wherein the data generation circuit generates alpha data values based on the extracted information and on a user-specified operating mode.

5. The apparatus of claim 4 wherein said user-specified operating mode is supplied to the data generation circuit by a mode select processor.

6. The apparatus of claim 1 wherein the first and second input processing blocks define the first and second frame-based video data as packetized data having header and data fields.

7. The apparatus of claim 1 wherein said first and second input processing blocks define the first and second frame-based video data as packetized data by extracting video and synchronization data from the video information received from the first and second sources respectively.

8. The apparatus of claim 1 further comprising first camera serving as said first source and a second camera serving as said second source, and wherein the first and second camera are unsynchronized with respect to each other.

9. The apparatus of claim 1 further comprising first camera serving as said first source and a second camera serving as said second source, each of said cameras having a clocking circuit that measures time independently of another clocking circuit.

10. The apparatus of claim 1 wherein the alpha blending mixer is configured to pull buffered video data from the first and second frame buffers when each contains a start-of-frame indicia and to thereby synchronize the first and second buffered video data for processing as a single blended video data frame.

11. The apparatus of claim 1 further comprising additional video data source coupled to said alpha blending mixer and wherein the alpha blending mixer is configured to blend additional video data with said first and second buffered video data to compose the single video output data.

12. The apparatus of claim 1 wherein the first and second alpha data generators selectively generate one of a plurality of different predefined 3D encoding formats selected from the group consisting of:
a first format in which alternating rows of pixels are suppressed;
a second format in which alternating columns of pixels are suppressed;
a third format in which a checkerboard matrix of pixels are suppressed;
a fourth format in which a contiguous region of pixels are suppressed.
